(19) United States
(12) Patent Application Publication
(10) Pub. No.: US 2018/0328475 A1
(43) Pub. Date: Nov. 15, 2018

(54) STATOR

(71) Applicant: EXEDY Corporation, Osaka (JP)

(72) Inventors: Yoshihiro KOJIMA, Osaka (JP); Masakatsu TOGAWA, Osaka (JP); Shigeo KAMIYA, Osaka (JP); Meiji YAMAUCHI, Osaka (JP)

(21) Appl. No.: 15/971,537

(22) Filed: May 4, 2018

(30) Foreign Application Priority Data
May 10, 2017 (JP) 2017-093838

(51) Int. Cl. F16H 41/24; F16D 33/04

(52) U.S. Cl. CPC F16H 41/24; F16H 2041/285; F16H 2041/246; F16D 33/04

(57) ABSTRACT

A stator includes a stator body member and a fixing member. The stator body member includes a first disc part, a plurality of first stator blades and a first ratchet portion. The plurality of first stator blades extend outward from the first disc part in a radial direction. The first ratchet portion is provided on a principal surface of the first disc part so as to extend in a circumferential direction. The fixing member is disposed in a non-rotatable state, and includes a second disc part and a second ratchet portion. The second ratchet portion is provided on a principal surface of the second disc part so as to extend in the circumferential direction, and is configured to be engaged with the first ratchet portion.

### CROSS-REFERENCE TO RELATED APPLICATIONS

This application claims priority to Japanese Patent Application No. 2017-093838 filed on May 10, 2017, the entirety of which is hereby incorporated by reference in its entirety.

### BACKGROUND

### Technical Field

The present disclosure relates to a stator for a torque converter.

### BACKGROUND INFORMATION

A torque converter includes an impeller, a turbine and a stator (e.g., Japan Laid-open Patent Application Publication No. 2016-211716). The stator is attached to a stator shaft, which is non-rotatable, through a one-way clutch. Therefore, the stator is configured to be rotated only in one direction.

An outer race is disposed between the one-way clutch and the stator so as to prevent the stator from deforming due to a load applied thereto through the one-way clutch.

### BRIEF SUMMARY

It is an object of the present disclosure to provide a stator that can reduce the number of components relevant thereto.

A stator according to an aspect of the present disclosure includes a stator body member and a fixing member. The stator body member includes a first disc part, a plurality of first stator blades and a first ratchet portion. The plurality of first stator blades extend outward from the first disc part in a radial direction. The first ratchet portion is provided on a principal surface of the first disc part so as to extend in a circumferential direction. The fixing member includes a second disc part and a second ratchet portion. The second ratchet portion is provided on a principal surface of the second disc part so as to extend in the circumferential direction. The second ratchet portion is configured to be engaged with the first ratchet portion. The fixing member is disposed in a non-rotatable state.

According to this configuration, with engagement between the first ratchet portion and the second ratchet portion, the stator body member is rotated in one direction without being rotated in the other direction. Additionally in this configuration, a load is hardly applied to the stator in the radial direction because rotation of the stator is restricted by the engagement of the first ratchet portion provided on the principal surface of the first disc part and the second ratchet portion provided on the principal surface of the second disc part. Therefore, it is possible to omit providing an outer race, whereby the number of components relevant to the stator can be reduced.

Preferably, the stator further includes an urging member. The urging member urges the fixing member toward the stator body member in an axial direction.

Preferably, the fixing member further includes a tubular part. Additionally, the second disc part extends outward from the tubular part in the radial direction.

Preferably, the stator further includes a retainer. The retainer includes a third disc part and a plurality of second stator blades extending outward from the third disc part in the radial direction. Additionally, the plurality of respective first stator blades and the plurality of respective second stator blades are aligned in the circumferential direction.

Preferably, at least a pair of the first and second stator blades disposed adjacently to each other in the circumferential direction partially overlaps in an axial view.

Preferably, the stator body member further includes a first engaging portion. The first engaging portion is disposed outside the first ratchet portion in the radial direction. Additionally, the first engaging portion is provided on the principal surface of the first disc part so as to extend in the circumferential direction. The retainer further includes a second engaging portion. The second engaging portion is provided on a principal surface of the third disc part and is engaged with the first engaging portion.

Overall, according to the stator of the present disclosure, the number of components relevant thereto can be reduced.

### BRIEF DESCRIPTION OF THE DRAWINGS

Referring now to the attached drawings which form a part of this original disclosure:

FIG. 1 is a front view of a stator;

FIG. 2 is a perspective view of the stator;

FIG. 3 is a cross-sectional view of FIG. 1 taken along line III-III;

FIG. 4 is a perspective view of a stator body member;

FIG. 5 is a perspective view of a fixing member;

FIG. 6 is a perspective view of the fixing Member assembled to the stator body member;

FIG. 7 is a perspective view of a retainer;

FIG. 8 is a perspective view of the retainer to which the fixing member is assembled;

FIG. 9 is a cross-sectional view of FIG. 1 taken along line IX-IX; and

FIG. 10 is a cross-sectional view of a stator according to a modification.

### DETAILED DESCRIPTION OF EMBODIMENTS

An exemplary embodiment of a stator according to the present disclosure will be hereinafter explained with reference to the attached drawings. It should be noted that in the following explanation, the term “axial direction” indicates an extending direction of a rotational axis O of the stator. On the other hand, the term “circumferential direction” indicates a circumferential direction of an imaginary circle about the rotational axis O, whereas the term “radial direction” indicates a radial direction of the imaginary circle about the rotational axis O. The term “radially outside” indicates a side separating from the rotational axis O in the radial direction, whereas the term “radially inside” indicates a side approaching to the rotational axis O in the radial direction.

[Stator]

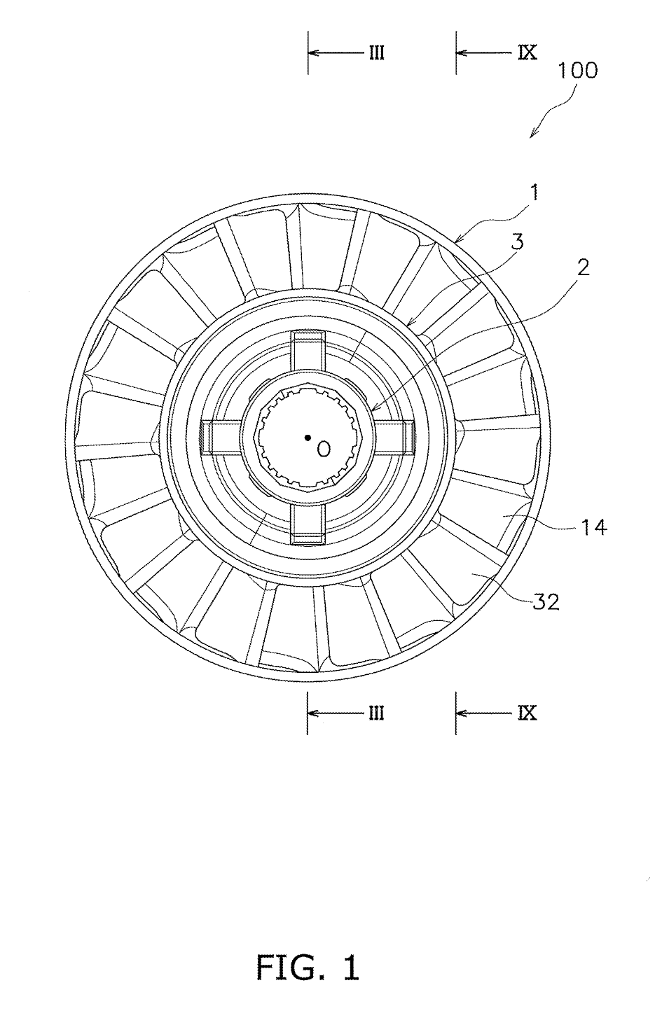

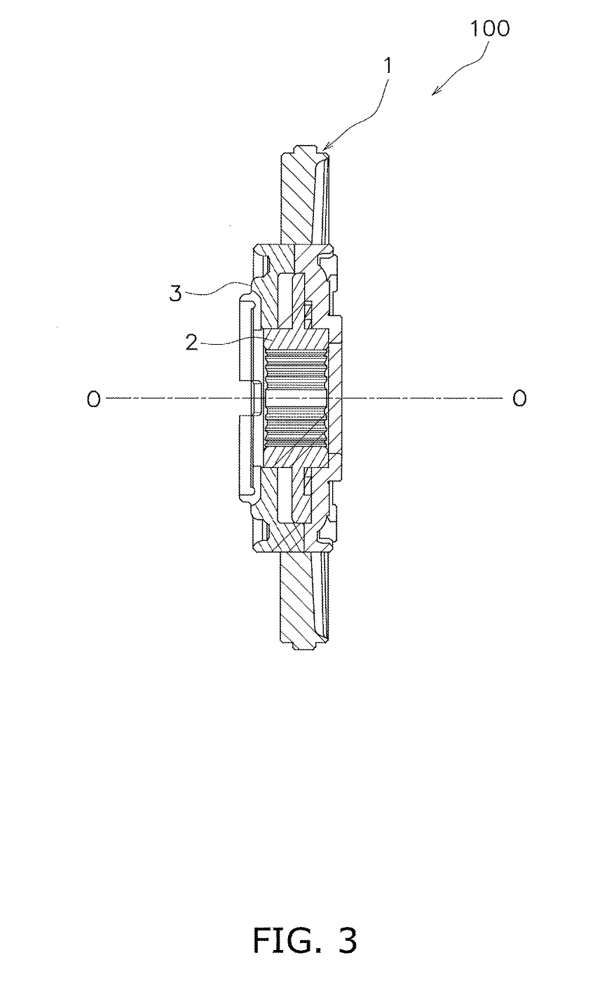

As shown in FIGS. 1 to 3, a stator 100 includes a stator body member 1, a fixing member 2 and a retainer 3. The stator 100 is rotatable about the rotational axis O. The stator body member 1 and the retainer 3 are fixed to each other, and are unitarily rotated. It should be noted that the fixing member 2 is not rotated. The stator body member 1 is disposed on a first side of the retainer 3 in the axial direction, whereas the retainer 3 is disposed on a second side of the stator body member 1 in the axial direction. The fixing member 2 is disposed between the stator body member 1 and the retainer 3.

[Stator Body Member]

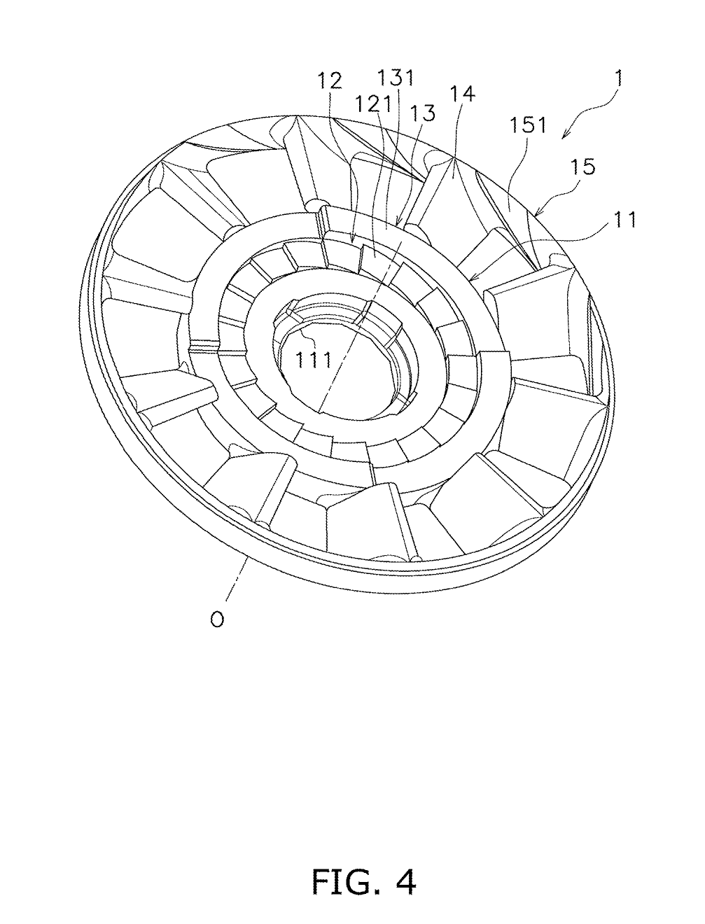

As shown in FIG. 4, the stator body member 1 includes a first disc part 11, a first ratchet portion 12, a first engaging portion 13, a plurality of first stator blades 14 and an outer tubular part 15. The first disc part 11, the first ratchet portion 12, the first engaging portion 13, the plural first stator blades 14 and the outer tubular part 15 are provided as a single member. For example, the stator body member 1 can be molded with a die by, for instance, casting, resin molding, compression molding or so forth.

First Disc Part

The first disc part 11 has a disc shape and includes a through hole 111 in the middle thereof. Each of the principal surfaces of the first disc part 11 faces in the axial direction. Of the principal surfaces of the first disc part 11, the surface facing the second side in the axial direction, in other words, the surface facing the fixing member 2 and the retainer 3, is provided with the first ratchet portion 12 and the first engaging portion 13.

First Ratchet Portion

The first ratchet portion 12 is provided on the principal surface of the first disc part 11 so as to extend in the circumferential direction. The first ratchet portion 12 is opposed to a second ratchet portion 22 to be described. Moreover, the first ratchet portion 12 is engaged with the second ratchet portion 22 only in an opposite direction to a rotational direction of the stator body member 1. Therefore, the stator body member 1 is rotated only in a predetermined direction but is not rotated in the opposite direction to the predetermined direction.

Specifically, the first ratchet portion 12 is composed of a plurality of first slopes 121 aligned on the principal surface of the first disc part 11 in the circumferential direction. Each first slope 121 reduces in height along the circumferential direction. It should be noted that the height of each first slope 121 means the axial dimension thereof. A step is formed in a boundary region of each adjacent pair of the first slopes 121. The step is engaged with a step formed in a boundary region of each adjacent pair of second slopes 221 of the second ratchet portion 22.

First Engaging Portion

The first engaging portion 13 extends on the principal surface of the first disc part 11 in the circumferential direction. The first engaging portion 13 is disposed radially outside the first ratchet portion 12. Specifically, the first engaging portion 13 is provided on the outer peripheral end portion of the first disc part 11. The first engaging portion 13 protrudes further than the first ratchet portion 12 in the axial direction. Similarly to the first ratchet portion 12, the first engaging portion 13 is composed of a plurality of third slopes 131. Each third slope 131 has a longer circumferential length than each first slope 121.

First Stator Blades

The respective first stator blades 14 extend radially outward from the outer peripheral surface of the first disc part 11. The respective first stator blades 14 are disposed at intervals from each other in the circumferential direction.

Each first stator blade 14 extends in the radial direction. Detailedly, each first stator blade 14 extends between the first disc part 11 and the outer tubular part 15 in the radial direction. Each first stator blade 14 has a plate shape and slants such that the principal surfaces thereof face not only in the axial direction but also in the circumferential direction. The thickness of each first stator blade 14 gradually reduces toward the first side in the axial direction.

The entirety of the radially outer end surface of each first stator blade 14 is disposed within the inner peripheral surface of the outer tubular part 15. On the other hand, part of the radially inner end surface of each first stator blade 14 protrudes from the outer peripheral surface of the first disc part 11 to the second side in the axial direction. The part of the radially inner end surface of each first stator blade 14 makes contact with the outer peripheral surface of a third disc part 31 of the retainer 3.

Outer Tubular Part

The outer tubular part 15 has a cylindrical shape and extends in the axial direction. The outer tubular part 15 includes a plurality of grooves 151 on the inner peripheral surface thereof. Each groove 151 is disposed between each pair of the first stator blades 14 located adjacently to each other in the circumferential direction. Each groove 151 slants to extend not only in the axial direction but also in the circumferential direction. The width of each groove 151 gradually reduces toward the first side in the axial direction.

[Fixing Member]

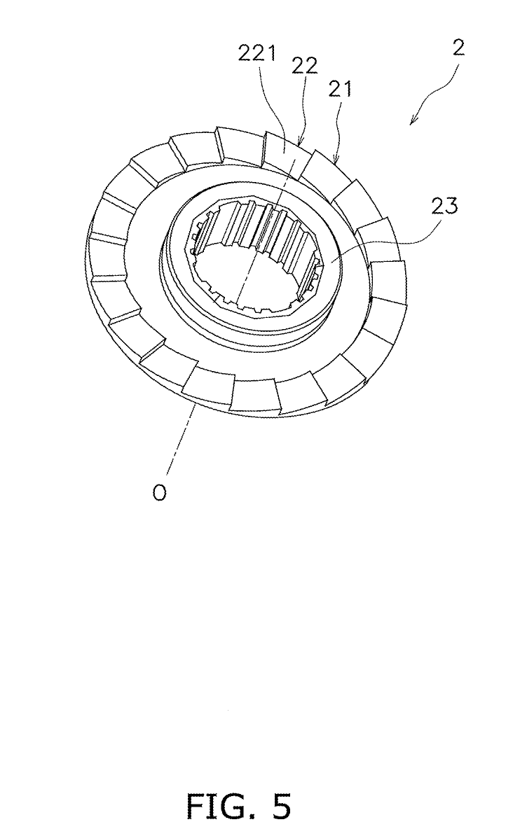

As shown in FIGS. 1 to 3, the fixing member 2 is disposed in a non-rotatable state. Specifically, the fixing member 2 is fixed to a stator shaft of a torque converter (not shown in the drawings). FIG. 5 is a perspective view of the fixing member 2 as seen from the first side in the axial direction. As shown in FIG. 5, the fixing member 2 includes a second disc part 21, the second ratchet portion 22 and a tubular part 23.

Second Disc Part

The second disc part 21 has a disc shape and the principal surfaces thereof face in the axial direction. Of the principal surfaces of the second disc part 21, the surface facing the first side in the axial direction, in other words, the surface facing the stator body member 1, is provided with the second ratchet portion 22.

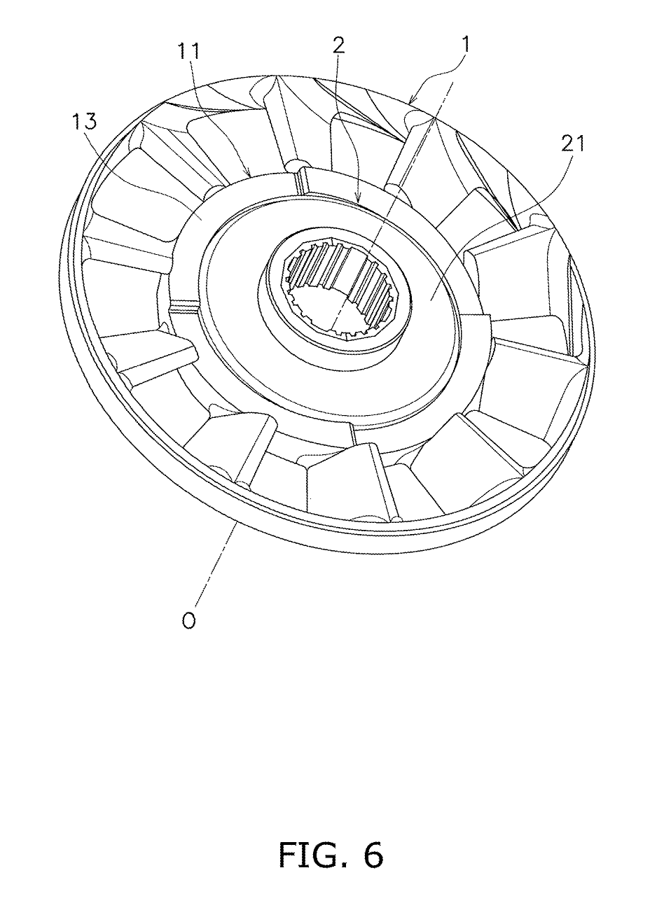

FIG. 6 is a perspective view of the fixing member 2 assembled to the stator body member 1. As shown in FIG. 6, the second disc part 21 has a smaller outer diameter than the first disc part 11. The second disc part 21 is accommodated in a space delimited by the first engaging portion 13.

Second Ratchet Portion

As shown in FIG. 5, the second ratchet portion 22 is provided on the principal surface of the second disc part 21 so as to extend in the circumferential direction. The second ratchet portion 22 is configured to be engaged with the first ratchet portion 12. As described above, the first ratchet portion 12 and the second ratchet portion 22 are engaged only in the predetermined rotational direction but are not engaged in the opposite rotational direction to the predetermined rotational direction.

Specifically, the second ratchet portion 22 is composed of the plural second slopes 221 aligned on the principal surface of the second disc part 21 in the circumferential direction. Each second slope 221 reduces in height along the circumferential direction. It should be noted that the height of each second slope 221 means the axial dimension thereof. A step is formed in a boundary region of each adjacent pair of the second slopes 221. The step is engaged with the step formed in the boundary region of each adjacent pair of the first slopes 121 of the first ratchet portion 12.

Tubular Part

The tubular part 23 has a cylindrical shape and extends in the axial direction. The second disc part 21 extends radially outward from the outer peripheral surface of the tubular part 23. The tubular part 23 includes spline grooves on the inner peripheral surface thereof. When the tubular part 23 and the stator shaft are spline-coupled, the fixing member 2 is fixed to the stator shaft in a non-rotatable state.

[Retainer]

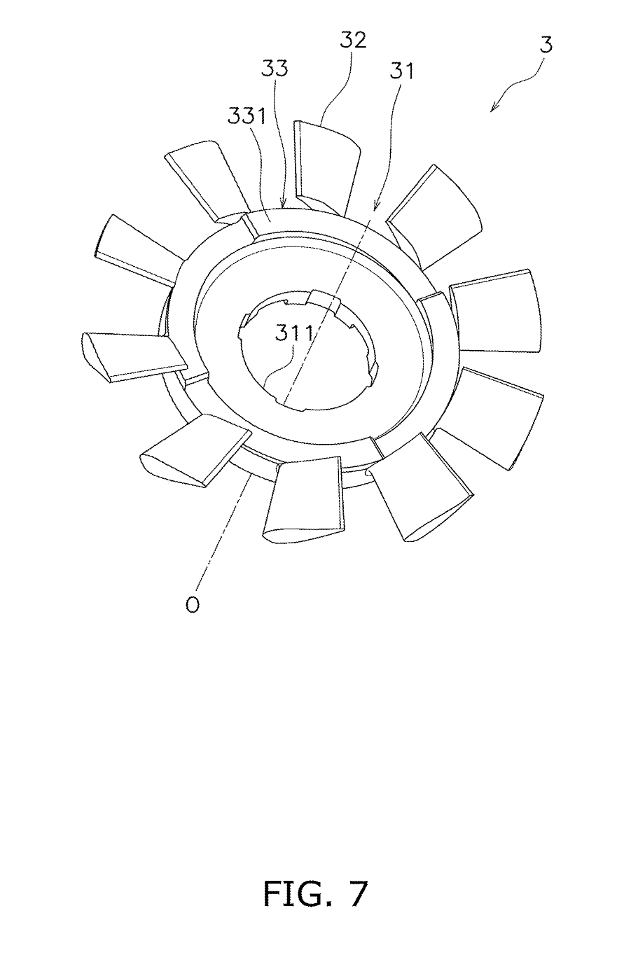

FIG. 7 is a perspective view of the retainer 3 as seen from the first side in the axial direction. As shown in FIG. 7, the retainer 3 includes the third disc part 31, a plurality of second stator blades 32 and a second engaging portion 33. The third disc part 31, the respective second stator blades 32 and the second engaging portion 33 are provided as a single member. For example, the retainer 3 can be molded with a die by, for instance, casting, resin molding, compression molding or so forth.

Third Disc Part 31

The third disc part 31 has a disc shape and includes a through hole 311 in the middle thereof. The tubular part 23 of the fixing member 2 penetrates the through hole 311 of the third disc part 31.

The principal surfaces of the third disc part 31 face in the axial direction. Of the principal surfaces of the third disc part 31, the surface facing the first side in the axial direction, in other words, the surface facing the stator body member 1, is provided with the second engaging portion 33.

The outer peripheral surface of the third disc part 31 and that of the first disc part 11 are substantially flush to each other. In other words, the outer diameter of the third disc part 31 and that of the first disc part 11 are substantially equal to each other.

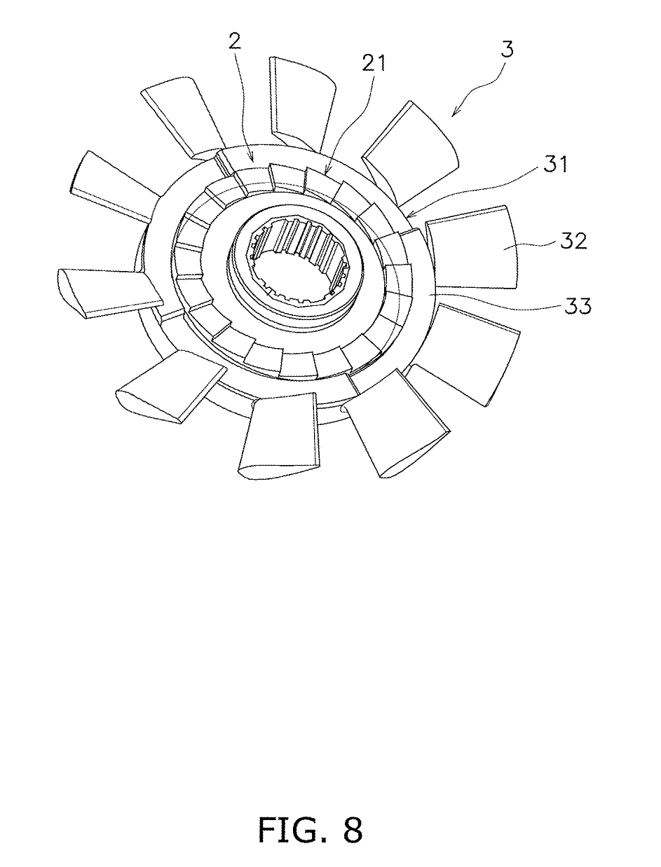

FIG. 8 is a perspective view of the retainer 3 to which the fixing member 2 is assembled. As shown in FIG. 8, the outer diameter of the third disc part 31 is greater than that of the second disc part 21 of the fixing member 2. The second disc part 21 is accommodated in a space delimited by the second engaging portion 33. In other words, the second disc part 21 is accommodated in the space delimited by the first engaging portion 13 and the second engaging portion 33.

Second Engaging Portion

As shown in FIG. 7, the second engaging portion 33 extends on the principal surface of the third disc part 31 in the circumferential direction. Specifically, the second engaging portion 33 is provided on the outer peripheral end portion of the third disc part 31. The second engaging portion 33 protrudes from the third disc part 31 in the axial direction. The second engaging portion 33 is engaged with the first engaging portion 13 in the circumferential direction. Similarly to the first engaging portion 13, the second engaging portion 33 is composed of a plurality of fourth slopes 331.

Second Stator Blades

Each second stator blade 32 extends in the radial direction. Detailedly, each second stator blade 32 extends radially outward from the outer peripheral surface of the third disc part 31. Each second stator blade 32 has substantially the same shape as each first stator blade 14 and also has substantially the same size as each first stator blade 14. Part of the radially inner end surface of each second stator blade 32 protrudes from the outer peripheral surface of the third disc part 31 to the first side in the axial direction. Additionally, the part of the radially inner end surface of each second stator blade 32 makes contact with the outer peripheral surface of the first disc part 11.

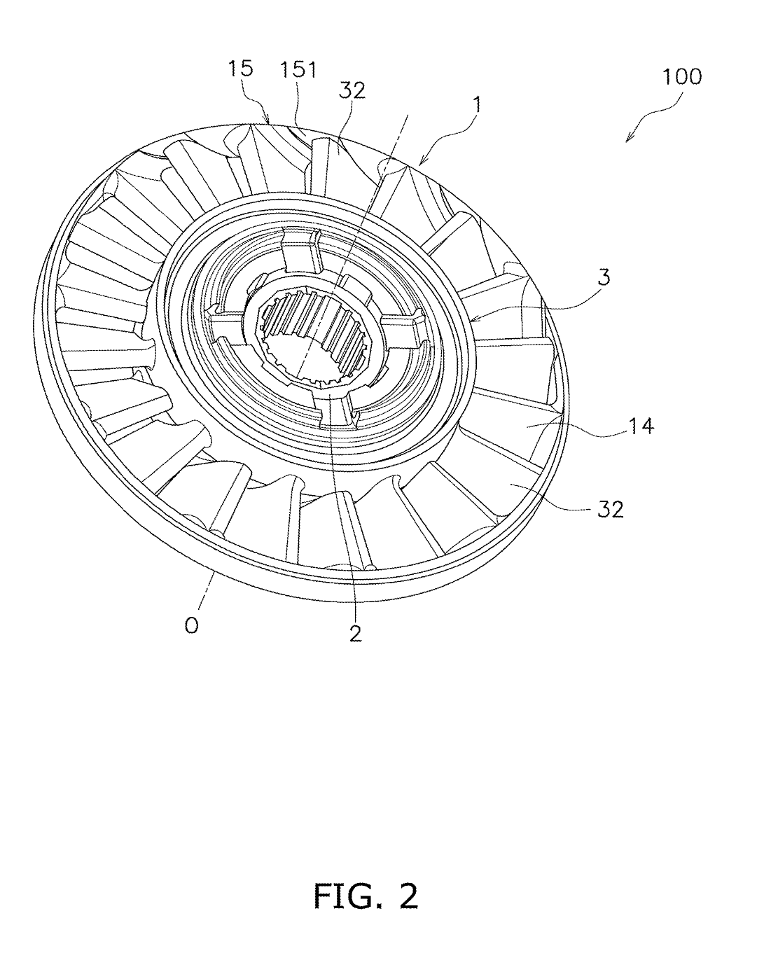

The respective second stator blades 32 are disposed at intervals from each other in the circumferential direction. As shown in FIGS. 1 and 2, the respective first stator blades 14 and the respective second stator blades 32 are aligned in the circumferential direction. Preferably, the respective first stator blades 14 and the respective second stator blades 32 are alternately aligned in the circumferential direction.

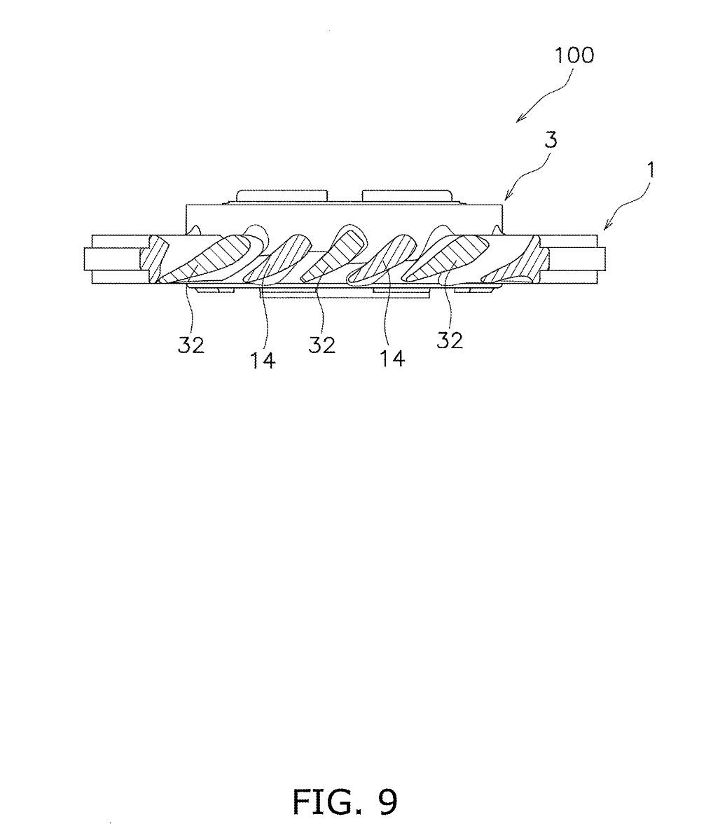

The circumferential length of each second stator blade 32 is longer than the interval between adjacent two of the first stator blades 14. Therefore, as shown in FIGS. 1 and 9, each pair of the first and second stator blades 14 and 32, disposed adjacently to each other in the circumferential direction, partially overlaps in an axial view. In other words, each adjacent pair of the first and second stator blades 14 and 32 overlaps at the adjacent circumferential end portions thereof in the axial view. Therefore, any interval is not produced between each adjacent pair of the first and second stator blades 14 and 32 in the axial view.

As shown in FIG. 2, the radially outer end portion of each second stator blade 32 is disposed within each groove 151 of the outer tubular part 15 of the stator body member 1. The stator body member 1 and the retainer 3 are positioned to each other with the configuration that the radially outer end portion of each second stator blade 32 is disposed within each groove 151.

The retainer 3, configured as described above, is fixed to the stator body member 1, and hence, is unitarily rotated with the stator body member 1. Detailedly, the retainer 3 is joined to the stator body member 1.

For example, the radially outer end surface of each second stator blade 32 and the inner peripheral surface of the outer tubular part 15 can be joined to each other. Additionally or alternatively, part of the radially inner end surface of each second stator blade 32 and the outer peripheral surface of the first disc part 11 can be joined to each other, and or alternatively, part of the radially inner end surface of each first stator blade 14 and the outer peripheral surface of the third disc part 31 can be joined to each other. Still additionally or alternatively, the first disc part 11 and the third disc part 31 can be joined to each other. It should be noted that a heretofore known method such as frictional press-contact can be employed as a joint method.

[Modifications]

One exemplary embodiment of the present advancement has been described above. However, the present advancement is not limited to this, and a variety of changes can be made without departing from the gist of the present advancement.

For example, in the aforementioned exemplary embodiment, the first stator blades 14 and the second stator blades 32 are alternately aligned. However, alignment of the first and second stator blades 14 and 32 is not particularly limited to this.

Additionally, in the aforementioned exemplary embodiment, each first stator blade 14 and each second stator blade 32 are configured to have substantially the same shape and the same size. However, the shape and size configuration of each first stator blade 14 and that of each second stator blade 32 are not particularly limited to this. In other words, each first stator blade 14 and each second stator blade 32 can have different shapes and different sizes.

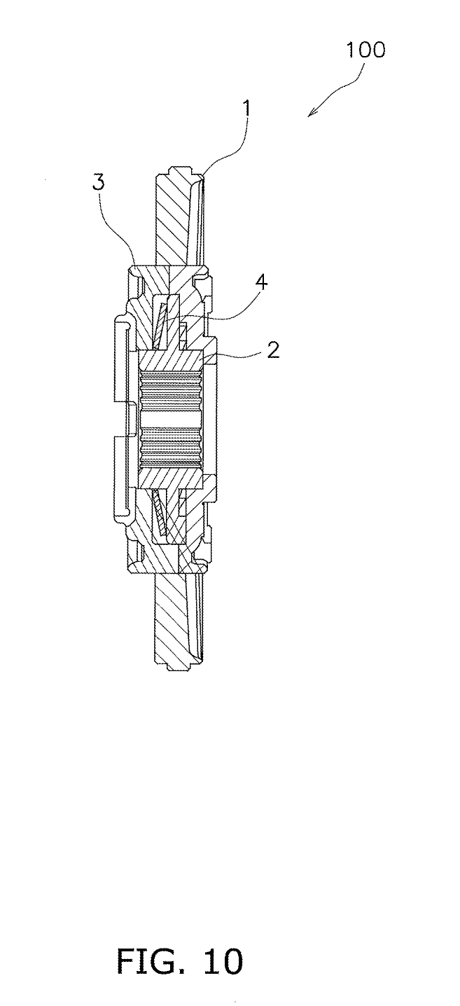

As shown in FIG. 10, the stator 100 can further include an urging member 4. The urging member 4 urges the fixing member 2 toward the stator body member 1 in the axial direction. The urging member 4 is, for instance, a disc spring.

What is claimed is:

1. A stator comprising:
a stator body member including a first disc part, a plurality of first stator blades and a first ratchet portion, the plurality of first stator blades extending outward from the first disc part in a radial direction, the first ratchet portion provided on a principal surface of the first disc part so as to extend in a circumferential direction; and
a fixing member disposed in a non-rotatable state, the fixing member including a second disc part and a second ratchet portion, the second ratchet portion provided on a principal surface of the second disc part so as to extend in the circumferential direction, the second ratchet portion configured to be engaged with the first ratchet portion.

2. The stator according to claim 1, further comprising:
an urging member for urging the fixing member toward the stator body member in an axial direction.

3. The stator according to claim 1, wherein
the fixing member further includes a tubular part, and
the second disc part extends outward from the tubular part in the radial direction.

4. The stator according to claim 1, further comprising:
a retainer including a third disc part and a plurality of second stator blades, the plurality of second stator blades extending outward from the third disc part in the radial direction, wherein
the plurality of respective first stator blades and the plurality of respective second stator blades are aligned in the circumferential direction.

5. The stator according to claim 4, wherein at least a pair of the first and second stator blades disposed adjacently to each other in the circumferential direction partially overlaps in an axial view.

6. The stator according to claim 4, wherein
the stator body member further includes a first engaging portion, the first engaging portion disposed outside the first ratchet portion in the radial direction, the first engaging portion provided on the principal surface of the first disc part so as to extend in the circumferential direction, and
the retainer further includes a second engaging portion, the second engaging portion being provided on a principal surface of the third disc part, the engaging portion to be engaged with the first engaging portion.
